(19) United States
(12) Patent Application Publication
(10) Pub. No.: US 2007/0222614 A1
(43) Pub. Date: Sep. 27, 2007

(54) System and method to monitor wear of an object

(76) Inventor: Patricia A. Rapp, Fairport, NY (US)

Correspondence Address: ROBERT D. GUNDERMAN, JR.;PATENT TECHNOLOGIES, LLC, 150 LUCIUS GORDON DRIVE, SUITE 205, WEST HENRIETTA, NY, 14586, US

(21) Appl. No.: 11/388,315

(22) Filed: Mar. 24, 2006

(51) Int. Cl. G08B 13/14; G08B 21/00

(52) U.S. Cl. 340/572.8; 340/540

(57) ABSTRACT

A system and method to monitor wear of an object that uses a radio frequency identification tag embedded in the object at a depth that is indicative of wear conditions of the object, a radio frequency transceiver in communication with the radio frequency identification tag, and a data processing subsystem that receives status information from the radio frequency transceiver and processes the status information to a user interface. When the object reaches a certain wear point, the radio frequency identification tag becomes exposed and damaged from the ongoing wear conditions, causing the radio frequency signal between the tag and the transceiver to cease, thus providing an indication that a wear point on the object has been attained.

### BACKGROUND OF THE INVENTION

1. Field of the Invention

This invention relates generally to a system and method for monitoring wear of an object, and more particularly to a system and method that uses radio frequency identification to monitor wear of an object.

2. Description of related art

The ability to monitor the wear of an object becomes increasingly important in situations where excessive or abnormal wear of the object can create damage to persons or property. An example of an object that wears down in normal use, and has the potential to create damage to persons or property if the worn object is not replaced, is a tire. Over the years, there have been various techniques to provide a visual indication of wear on a tire. Materials or textures may be introduced into the wear surface of a tire that indicate wear by changing appearance. For example, a tread pattern may be introduced into the tire that will wear off at a given time to indicate that the tire needs replacement due to wear. Tread wear indicator bars are often times used by tire manufacturers to indicate wear. Tread wear indicator bars, also known as wear bars, are narrow raised bands (approximately 2/32 inch tall) that appear in the grooves across the tread of the tire. When the tread wear indicators are even with the tread depth, only 2/32 inch of tread remains, and it is time to replace the tire. Other techniques to visually indicate wear include rubber or other materials that use a color that contrasts with that of the object under wear, and either appears or disappears as the object wears.

These visual approaches to wear indication, although inexpensive, have numerous shortcomings. Such a system requires an educated and motivated owner to ensure regular visual inspections. In addition, such a system may not be suitable for objects with abnormal wear patterns or objects whose wear may be difficult to see or evaluate. Also, in environments where tires are routinely covered with snow, mud, or other debris, such a system becomes ineffective.

Other means of monitoring objects for wear have also been used. There are many systems which premise that an object whose wear must be monitored is placed in proximity to sensors that report changes in the object. The shortcomings of such systems include cost and robustness. Such systems routinely require complex sensors because of the challenge of monitoring the changing state of the object. Such sensors increase the cost of the system, and the processing of data from such sensors introduces additional failure points in the system.

Typical of such complex systems is Department of Transportation National Highway Traffic Safety Administration 49 CFR Part 571 [Docket No. NHTSA 2000-8572] RIN 2127-AI33 Federal Motor Vehicle Safety Standards: Tire Pressure Monitoring Systems; Controls and Displays where sensors are used for the purpose of monitoring tire pressure.

Direct Tire Pressure Monitoring Systems (TPMS) use pressure sensors, located in each wheel, to directly measure the pressure in each tire. These sensors broadcast data via a wireless radio frequency transmitter to a central receiver which analyzes the data. The central receiver is connected to a display mounted inside the vehicle. The type of display varies from a simple telltale indicator to a display showing the pressure and temperature in each tire, sometimes including the spare tire. Thus, direct TPMSs can be linked to a display that tells the driver which tire is under-inflated. An example of a vehicle currently equipped with a direct system is the Chevrolet™ Corvette™.

These Tire Pressure Monitoring Systems (TPMS) are also battery operated to remain functional when the car is not running. Clearly the overall system (from sensing to display) incurs additional costs, requires that it be built into the vehicle, and introduces many points of failure and subsequent maintenance issues.

It is an object of the present invention to provide a system and method for monitoring the wear of objects without the need for visual inspection of each object. It is another object of the present invention to provide a system and method for remotely monitoring the wear of objects using radio frequency identification. It is another object of the present invention to provide a system and method for monitoring the wear of objects that alerts a user to critical wear points. These and other objects of the present invention are provided by way of this specification and the claims provided herein.

### BRIEF SUMMARY OF THE INVENTION

In accordance with the present invention, there is provided a system and method to monitor wear of an object, the system comprising a radio frequency identification tag embedded in the object at a depth that is indicative of wear conditions of the object, a radio frequency transceiver in communication with the radio frequency identification tag, and a data processing subsystem that receives status information from the radio frequency transceiver and processes the status information to a user interface.

The foregoing paragraph has been provided by way of introduction, and is not intended to limit the scope of the following claims.

### BRIEF DESCRIPTION OF THE DRAWINGS

The invention will be described by reference to the following drawings, in which like numerals refer to like elements, and in which:

FIG. 1 is an illustration showing the wear monitoring system in use on an automobile;

FIG. 2 is a cutaway view of a tire and wheel showing an RFID tag and RF transceiver;

FIG. 3 is a sectional view of a tire showing an RFID tag in place;

FIG. 3A is a sectional view of a tire showing staggered RFID tags in place;

FIG. 4 is an underside plan view of an automobile showing various components of the wear monitoring system;

FIG. 5 is a block diagram of the wear monitoring system;

FIG. 6 is a functional diagram of a drive-on monitoring system;

FIG. 7 is a functional diagram of a handheld monitoring system;

FIG. 8 is a flowchart depicting logic flow of a single RFID tag system; and

FIG. 9 is a flowchart depicting logic flow of a staggered RFID tag system.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by the appended claims.

### DESCRIPTION OF THE PREFERRED EMBODIMENTS

For a general understanding of the present invention, reference is made to the drawings. In the drawings, like reference numerals have been used throughout to designate identical elements.

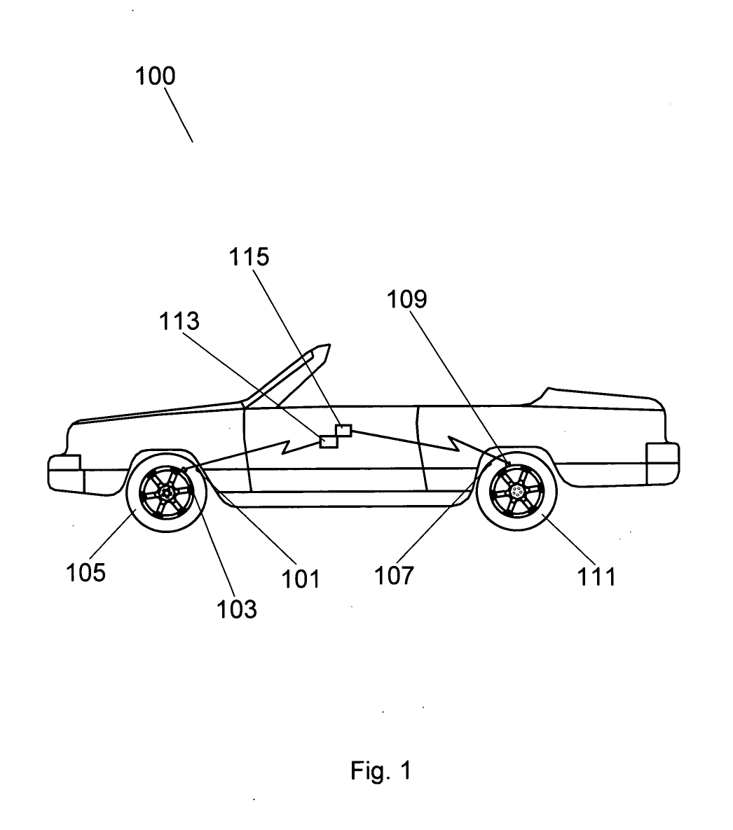

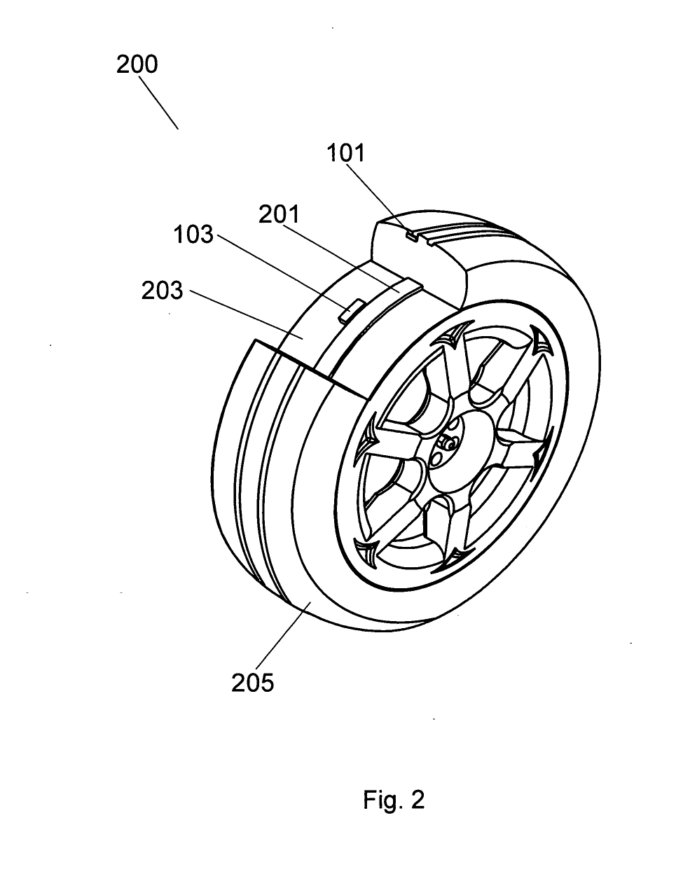

FIG. 1 is an illustration showing the wear monitoring system in use on an automobile, specifically monitoring the wear of tires on the automobile. As will become evident through this specification, the system and method of the present invention is suited to monitoring wear on numerous objects, such as, but not limited to, tires, belts, hoses, rollers, pinch rollers, gears, skids, and the like. Referring now to FIG. 1, a typical application of the wear monitoring system of the present invention is depicted. In FIG. 1 an automobile 100 is shown with the wear monitoring system of the present invention being used to monitor the wear of tires. In each tire, a radio frequency identification tag is inserted to a specific depth related to a wear point of the tire. As the tire wears, the radio frequency identification tag is eventually exposed and destroyed. When the radio frequency identification tag is destroyed, it no longer has the ability to return a signal when interrogated. The destruction of the radio frequency identification tag and resultant inability to return a signal when interrogated indicates that the tire is worn to a level that requires attention. In FIG. 1, the left front radio frequency identification tag 101 is shown embedded in the left front tire 105. The left rear radio frequency identification tag 107 is also shown embedded in the left rear tire 111. A transceiver is used to both interrogate the radio frequency identification tag and to communicate with other functional elements. A left front transceiver 103 is depicted within the tire 105. In addition, a left rear transceiver 109 is depicted within the tire 111. The transceiver may, in some embodiments of the present invention, be contained within a tire assembly and mounted, for example, on a wheel, as will be later described by way of FIG. 2. The transceiver may also be mounted to any location that is in proximity to the radio frequency identification tag with which it communicates. The remaining tires that are not visible in FIG. 1 also each contain a radio frequency identification tag and a transceiver.

Each transceiver, such as the left front transceiver 103 and the left rear transceiver 109 that can be seen in FIG. 1, are in wireless communication with a data processing subsystem 113. The data processing subsystem 113 receives data from the various transceivers that are in use. The data that the data processing subsystem 113 receives from the various transceivers in use relates to the presence or the absence of a signal from each radio frequency identification tag embedded in each tire. The absence of a signal from the radio frequency identification tag indicates that a wear point on the tire has been reached, and the radio frequency identification tag that monitors that wear point has been destroyed, indicating that the wear point has been reached. The data processing subsystem 113 also contains a user interface such as a display 115. The display 115 provides messages to a user related to the wear status of each tire.

FIG. 2 portrays a tire and wheel assembly 200 that contains a radio frequency identification tag and transceiver. The tire 205 may be formed from conventional materials such as rubber or rubber composites and may, for example, comprise a radial ply or a bias ply configuration. Embedded at a depth within the tire 205 is a radio frequency identification tag 101. The depth of the radio frequency identification tag within the tire is determined by such factors as the tread pattern, the hardness of the tire, the point at which a wear indication is desired, and the like. These factors may vary by tire type, and will be known by the tire manufacturer, tire designer, or other parties skilled in the art. The radio frequency identification tag 101 may, in some embodiments of the present invention, be embedded at a specified depth below the surface of the tread during the manufacturing process of the tire 205. In one embodiment of the present invention, the radio frequency identification tag is placed in the tread extrusion at a given depth prior to final assembly and cure of the tire. In another embodiment of the present invention, the radio frequency identification tag is placed within the tread of the tire in a post-cure assembly stage, as described in U.S. Pat. No. 6,978,669 entitled “Method and Assembly of Sensor Ready Tires” to Lionetti et al, the entire disclosure of which is herein incorporated by reference. Other techniques to embed objects and materials in a tire are well known to those skilled in the art.

Turning now to the radio frequency identification tag 101 that is depicted in FIG. 2, various types of radio frequency identification tags are known in the art. For example, various carrier frequencies are used in radio frequency identification tags. Passive radio frequency identification tags are those that do not require an internal energy source, but rather, are powered by radio frequency energy received through a passive resonant circuit attached to the radio frequency identification tag. The configuration and sizing of the passive resonant circuit is commonly specified by the manufacturer of the radio frequency identification tag. In a preferred embodiment of the present invention, an anti-collision feature is contained within the radio frequency identification tag to allow multiple tags to be read simultaneously. Anti-collision functionality is known to those skilled in the art. An example of a radio frequency identification tag with anti-collision functionality is the MCRF355 13.56 MHz passive RFID device with Anti-Collision Feature manufactured by Microchip Technology, Inc. Other frequency ranges for radio frequency identification tags may also be used, such as, but not limited to, 125 Kilohertz, such as the MCRF250 125 kHz MicroID™ Passive RFID Device with Anti-Collision manufactured by Microchip Technology, Inc., or the 13.56 Megahertz frequency, such as the MCRF450/451/452/455 13.56 MHz Read/Write Passive RFID Device by Microchip Technology, Inc.

Many radio frequency identification tags require an external passive resonant circuit and often times an antenna, for proper operation. In some embodiments of the present invention, the peripheral elements to the radio frequency identification tag such as the passive resonant circuit and the antenna may be dislocated from the radio frequency identification tag itself. For example, the antenna or the passive resonant circuit may be placed within the tread of a tire, and the radio frequency identification tag may be located deeper within the tire. This topology would allow for the activation of a wear indicator signal when the antenna or passive resonant circuit is exposed and destroyed through normal wear of the object.

Continuing to refer to FIG. 2, a transceiver 103 is shown. The transceiver 103 contains a radio frequency identification tag reader that transmits a radio frequency signal to the radio frequency tag 101 and receives a return signal from the radio frequency identification tag 101 if the wear point of the object has not been reached. If the wear point of the object has been reached, a portion of the radio frequency identification tag 101 has been destroyed, and the radio frequency identification tag 101 will not return a signal to the transceiver 103. Upon detection of this event, the transceiver 103 will in turn transmit a signal to a data processing subsystem 113 (not shown in FIG. 2) indicating that a radio frequency identification tag is not returning a signal and a wear point has been reached.

The transceiver 103, as shown in FIG. 2, is mechanically attached to the wheel 203 of an automotive tire assembly. In some embodiments of the present invention, the transceiver is mechanically attached to the wheel 203 of an automotive tire assembly with a strap 201. The strap 201 may, in some embodiments of the present invention, be a hose clamp style strap. In some embodiments of the present invention, the transceiver may be attached to the wheel of an automotive tire assembly using a bolt, screw, rivet, or any such fastener known to those skilled in the art. The transceiver 103 may also be mounted to the valve stem opening in the wheel 203, or otherwise mechanically mounted to the tire and wheel assembly of a vehicle. The transceiver 103 may also be mounted to any location that is free of radio frequency interfering obstructions between the radio frequency identification tag 101 and the transceiver 103.

The transceiver 103 primarily serves to interrogate the radio frequency identification tag 101 and to transmit status information received from the radio frequency identification tag 101 to a data processing subsystem or other monitoring system. Many automobiles today are made primarily of metal. Metal creates interference problems with many of today's radio frequency identification tags. Metal interference problems can often times be overcome with good system design and engineering. In some embodiments of the present invention, the object that is being monitored for wear may in fact be a metal. Examples include, but are not limited to, gears, pulleys, engine components, and the like. In the absence of metal interference problems, the transceiver functionality may, in some embodiments of the present invention, be contained within the data processing subsystem or external monitoring system.

In some embodiments of the present invention, the transceiver 103 may contain an internal power source such as a battery or an ultracapacitor. To extend battery life, a motion sensing circuit may be included in the transceiver 103 such that the transceiver circuitry is deactivated when the vehicle or other object is not in use. The transceiver 103 may also, in some embodiments of the present invention, be integrated with a tire pressure monitoring system such as the systems prescribed by Department of Transportation National Highway Traffic Safety Administration, 49 CFR Part 571 [Docket No. NHTSA 2000-8572] RIN 2127-AI33 Federal Motor Vehicle Safety Standards: Tire Pressure Monitoring Systems; Controls and Displays. In other embodiments of the present invention, the transceiver 103 may be powered from the motion of the object being monitored, using the principles of faraday's law of induction.

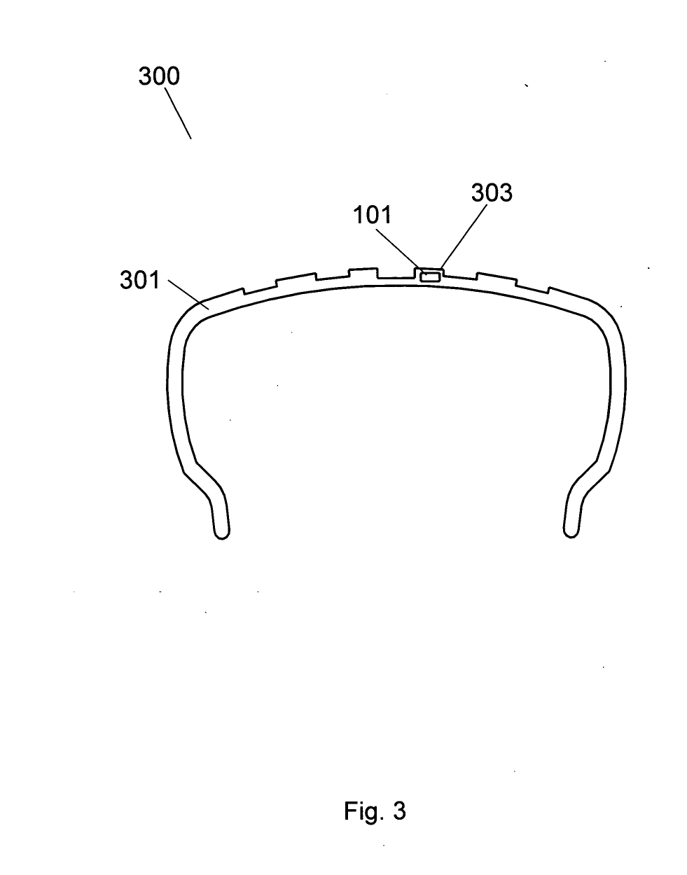

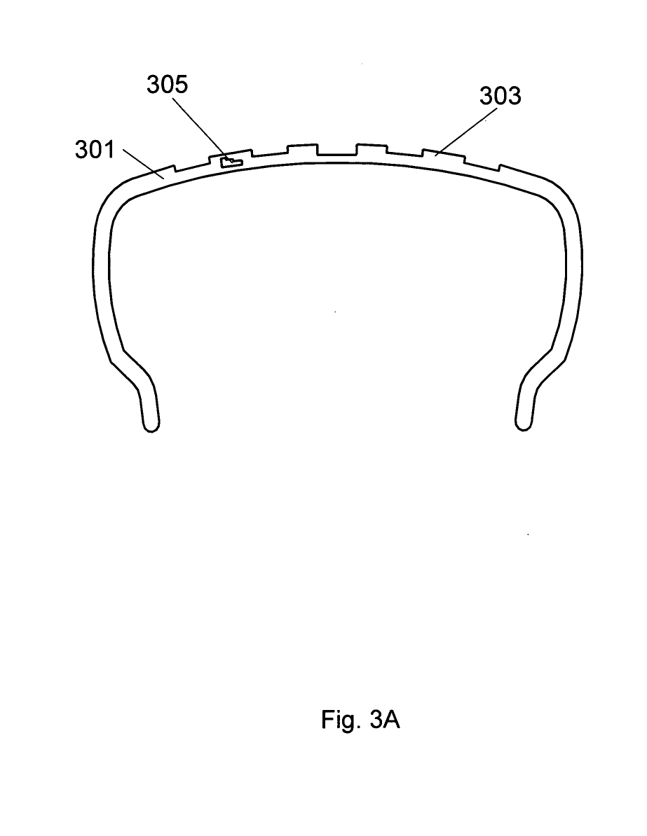

Referring now to FIG. 3, a sectional view of a tire is shown. A radio frequency identification tag 101 is embedded in the tire material 301 either during the tread extrusion process, prior to the curing process, or in a post cure operation such as that described in U.S. Pat. No. 6,978,669 entitled “Method and Assembly of Sensor Ready Tires” to Lionetti et al, the entire disclosure of which is herein incorporated by reference. The radio frequency identification tag 101 is often times embedded in a tire tread 303 to a depth that, when the radio frequency identification tag 101 becomes exposed, would be indicative of tire wear or a specified tire wear point.

FIG. 3A shows a sectional view of a tire showing staggered radio frequency identification tags. In some embodiments of the present invention, it is desirable to monitor not only a single wear point, but to monitor the progressive wear on an object. Objects in which progressive wear monitoring is desirable may include tires, belts, hoses, gears, tracks, skids, and the like. Within the tire material 301, there may be embedded a plurality of radio frequency identification tags such as the staggered radio frequency identification tags 305 depicted in FIG. 3A. As the object wears, each radio frequency identification tag that comprises the staggered radio frequency identification tags 305 is exposed in progression. Each radio frequency identification tag is embedded in the tire material 301 at a different depth below the tread 303 such that the failure of a specific radio frequency identification tag within the staggered radio frequency identification tags 305 is indicative of a wear point. Similar to the functionality of a single radio frequency identification tag used to monitor the wear of an object, when a given radio frequency identification tag within the staggered radio frequency identification tags 305 is exposed and damaged, the unique identifying signaling between that given radio frequency identification tag and a transceiver is halted, thus providing information to a data processing subsystem or monitoring system that the object has achieved a wear point that has been specified by the placement of the given radio frequency identification tag.

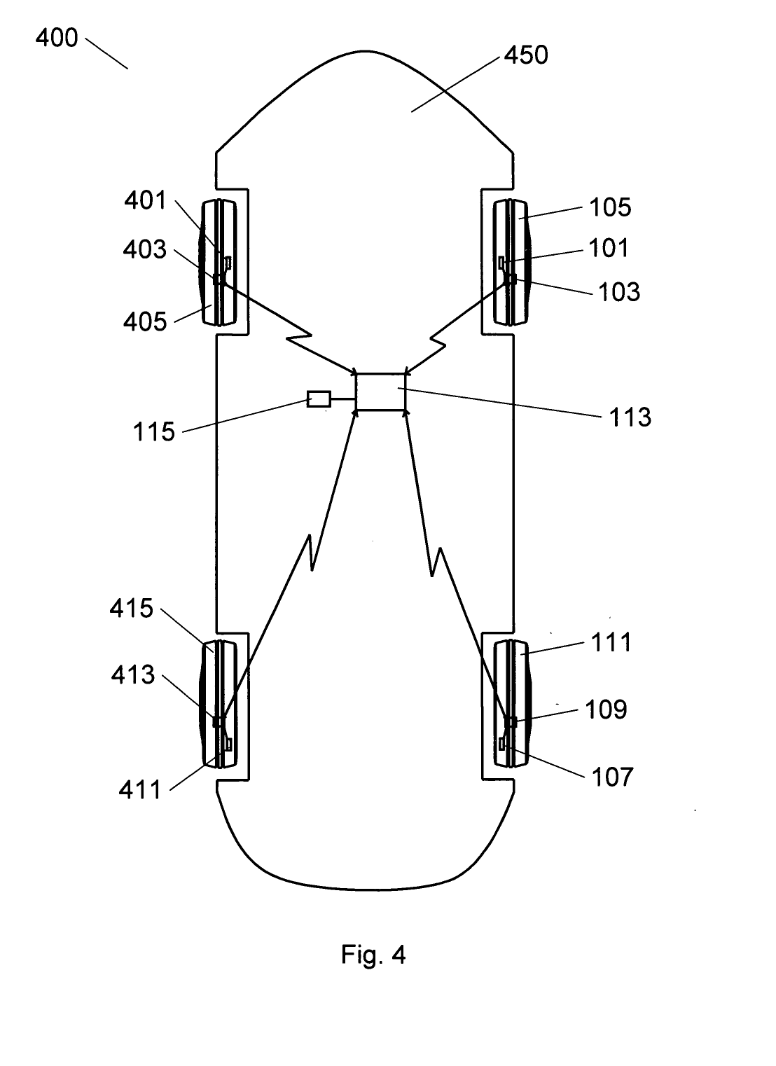

FIG. 4 is an underside plan view of an automobile 450 showing various components of the wear monitoring system. The left front tire 105 contains a left front radio frequency identification tag 101 and a left front transceiver 103. The right front tire 405 contains a right front radio frequency identification tag 401 and a right front transceiver 403. The left rear tire 111 contains a left rear radio frequency identification tag 107 and a left rear transceiver 109. The right rear tire 415 contains a right rear radio frequency identification tag 411 and a right rear transceiver 413. Each transceiver interrogates the corresponding radio frequency identification tag to ensure that a tire wear point has not been reached. If the corresponding radio frequency identification tag does not respond to the transceiver, a wear point has been reached and the transceiver will transmit this information to a data processing subsystem 113. The data processing subsystem contains a user interface such as a display 115 to provide a visual, and optionally, an audible, signal to the operator of the vehicle that a wear point on a tire has been reached. Examples of messages provided may include:

“Tread is getting low”

“Tread is worn. Time for replacement”

“Tread is dangerously low. Replace tire immediately”

Other indications provided on the display 115 may include messaging with an indication of tire location, a color coding system of red, yellow and green for each tire, and the like. The messaging from the data processing subsystem 113 may also be sent to an existing computer system and may, in some embodiments of the present invention, be sent to a maintenance interface such as an OBD-II interface.

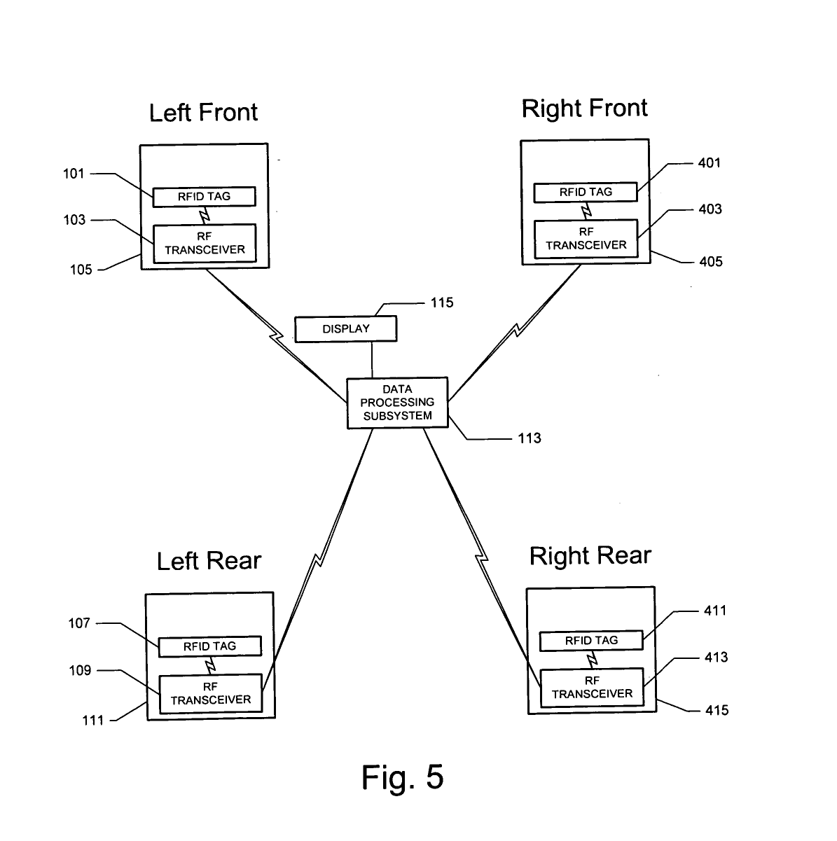

FIG. 5 is a block diagram of the wear monitoring system showing the interconnections between the various system elements. In some embodiments of the present invention, the RF transceivers may be functionally contained within the data processing subsystem 113. The block diagram of FIG. 5 is exemplary of an automobile with four tires, however, the system and method of the present invention are equally well suited to two wheeled vehicles such as motorcycles, as well as vehicles with more than four wheels, such as trucks and tractor-trailer rigs. In addition, the invention is equally well suited to non-automotive applications such as the monitoring of wear on skids, belts, tracks, gears, rollers, and the like.

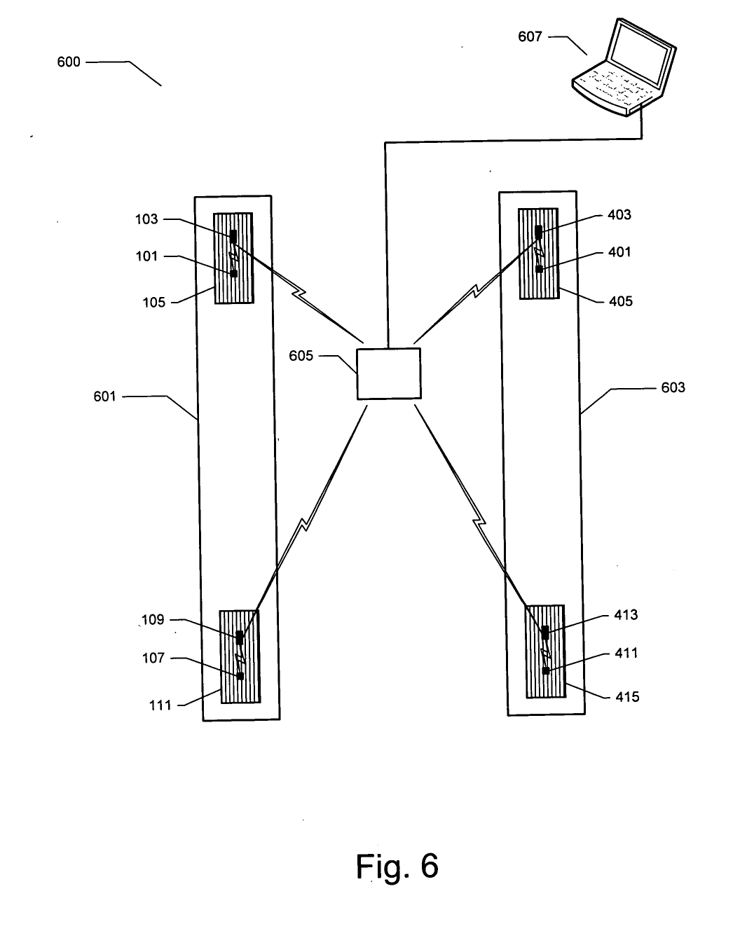

Referring now to FIG. 6, a functional diagram of a drive-on monitoring system is depicted. In the diagram, four tires 105, 111, 405 and 415 of an automobile are shown. Each of the tires contains a radio frequency identification tag and a transceiver, as previously disclosed in this specification. When an automobile enters a facility for servicing a vehicle, interrogators such as the left interrogator 601 and the right interrogator 603, are located in or adjacent to the floor of the service facility, and are capable of receiving the radio frequency signal from the transceivers 103,109,403 and 413 respectively. In some embodiments of the present invention, the interrogators are capable of communicating directly with the radio frequency identification tags 101, 107, 401 and 411. The interrogators 601 and 603 may also be combined into a single interrogator, or may be divided into more than two interrogators. The interrogators are connected to a data processing subsystem 605 or another radio frequency identification automotive service systems such as, for example, the one described in U.S. Pat. No. 6,982,653 entitled “Radio Frequency Identification Automotive Service Systems” to Voeller and Clasquin, the entire disclosure of which is incorporated herein by reference. In some embodiments of the present invention, the data processing subsystem 605 interfaces with a user interface device 607 such as a personal computer, a laptop computer, a terminal, or the like.

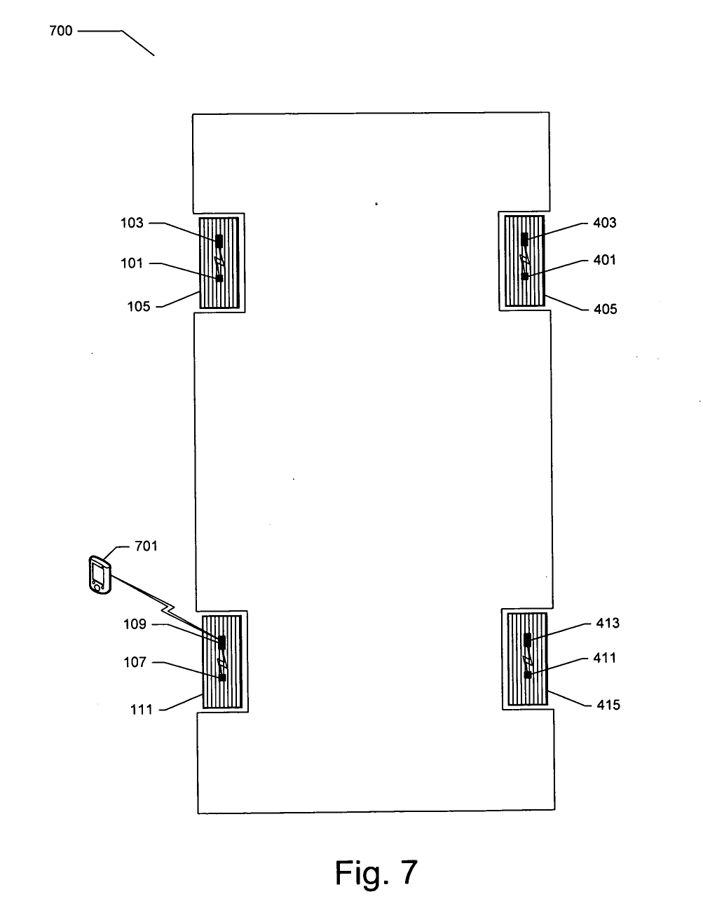

Turning now to FIG. 7, a functional diagram of a handheld monitoring system is shown. In the diagram, four tires 105, 111, 405 and 415 of an automobile are shown. Each of the tires contains a radio frequency identification tag and a transceiver, as previously disclosed in this specification. A handheld device 701 that is capable of receiving the radio frequency signal from the transceivers 103,109,403 and 413 is used to retrieve and process wear status indicators. In some embodiments of the present invention, the handheld device 701 is capable of communicating directly with the radio frequency identification tags 101, 107, 401 and 411. The handheld device 701 may also provide wear status data to another computer system, or to a radio frequency identification automotive service system such as, for example, the one described in U.S. Pat. No. 6,982,653 entitled “Radio Frequency Identification Automotive Service Systems” to Voeller and Clasquin, the entire disclosure of which is incorporated herein by reference. To use the handheld device 701, a user can walk around the car and poll each tire individually by pointing the reader at a particular tire and allowing the reader to send a signal to the radio frequency identification tag embedded in the tire. If the radio frequency identification tag responds, the user will go to the next tire to check for a response, and so on until all tires are checked. The lack of a response from any tire is indicative of wear, and data may be sent to a computer for further processing, including printing a work order and incorporating the information into the service record for the vehicle.

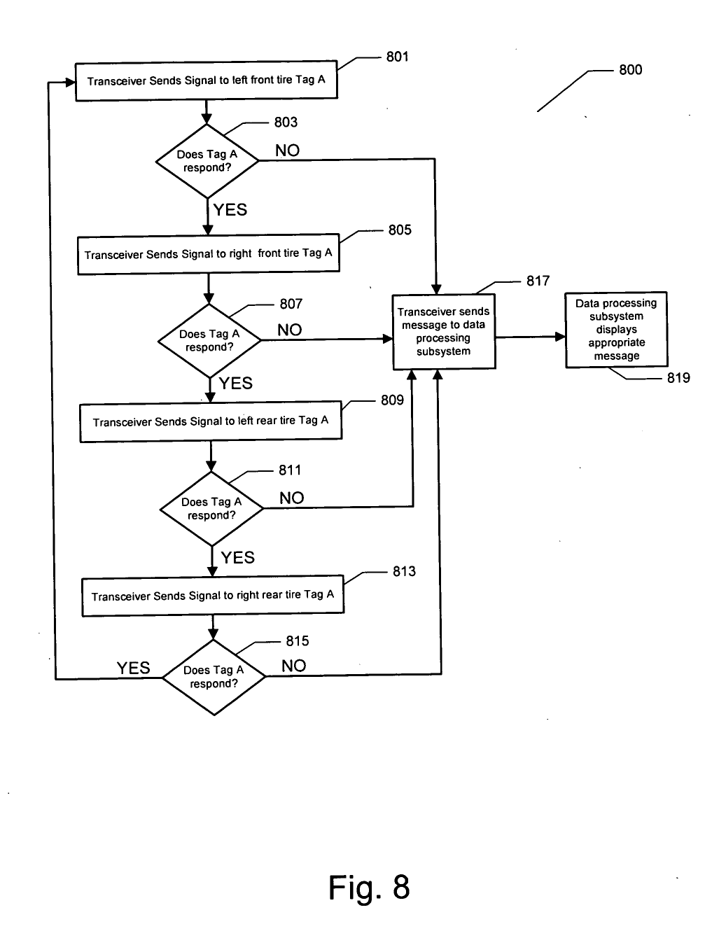

FIG. 8 is a flowchart 800 depicting logic flow of a single RFID tag system. To begin, a transceiver sends a signal to the left front radio frequency identification tag in step 801. If the left front radio frequency identification tag responds in step 803, the next radio frequency identification tag is interrogated in a similar manner. The interrogation of all of the radio frequency identification tags in the system continues. If an interrogated radio frequency identification tag does not respond, the transceiver messages the data processing subsystem in step 817, and the data processing subsystem displays an appropriate message in step 819, such as an indication of the severity of the wear and the affected tire. The process of interrogating all of the radio frequency identification tags in the system continues to loop, providing ongoing status of the wear of each object, in this case, automotive tires.

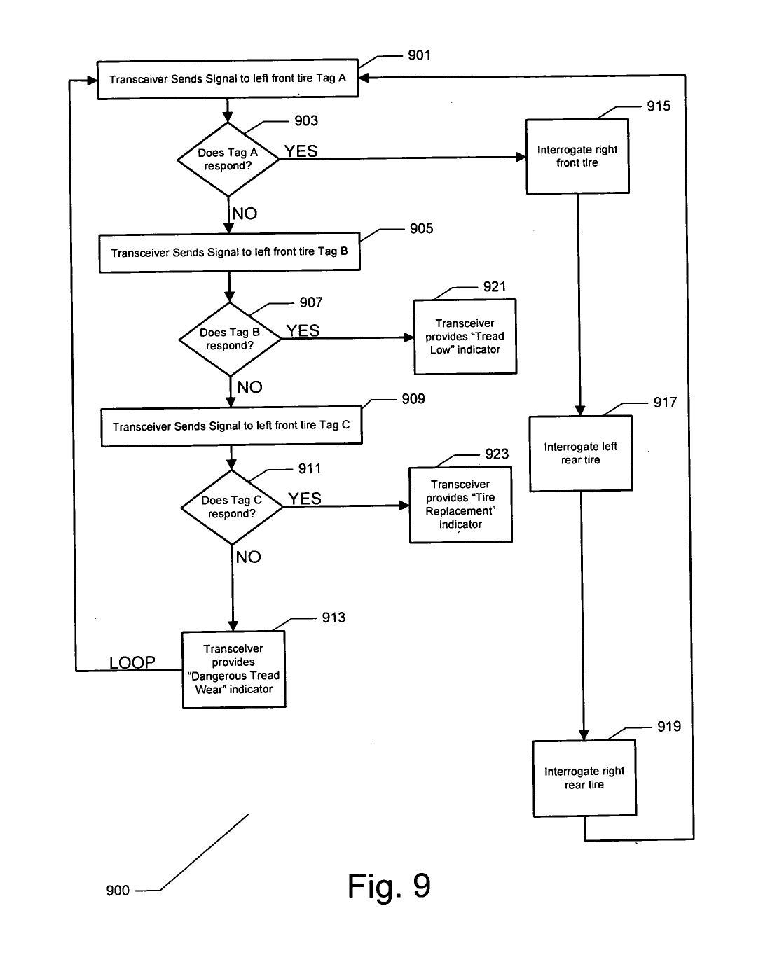

FIG. 9 is a flowchart 900 depicting logic flow of a staggered RFID tag system. The logic flow is a variation on the logic flow presented by way of FIG. 8, but further includes interrogation of multiple radio frequency identification tags within each tire. In step 901, a transceiver sends a signal to the left front tire radio frequency identification tag A. If radio frequency identification tag A responds, the first wear point on the left front tire has not been met, and the remaining tires are interrogated in steps 915, 917, and 919. If radio frequency identification tag A does not respond in step 903, the transceiver sends a signal to the left front tire tag B in step 905. If radio frequency identification tag B responds in step 907, the transceiver provides a “Tread Low” indicator in step 921 and interrogation of subsequent tags continues. If the radio frequency identification tag B does not respond in step 907, the transceiver sends a signal to left front tire radio frequency identification tag C. If radio frequency identification tag C responds in step 911, the transceiver provides a “Tire replacement” indicator. If radio frequency identification tag C does not respond in step 911, the transceiver provides a “dangerous tread wear indicator” in step 913, and radio frequency identification tag interrogation continues. If there are additional radio frequency identification tags contained in the staggered radio frequency identification tag assembly, interrogation continues in a similar manner to that described above. The remaining tires are further interrogated in a similar manner to the method described for the left front tire.

It is, therefore, apparent that there has been provided, in accordance with the various objects of the present invention, a system and method to monitor wear of an object. While the various objects of this invention have been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A system to monitor wear of an object comprising:
a radio frequency identification tag embedded in the object at a depth that is indicative of wear conditions of the object;
a radio frequency transceiver in communication with the radio frequency identification tag; and
a data processing subsystem that receives status information from the radio frequency transceiver and processes the status information to a user interface.

2. The system as recited in claim 1, wherein said object is a tire.

3. The system as recited in claim 1, wherein said object is a roller.

4. The system as recited in claim 1, wherein said object is a hose.

5. The system as recited in claim 1, wherein said object is a gear.

6. The system as recited in claim 1, wherein said object is a pulley.

7. The system as recited in claim 1, wherein said object is a belt.

8. The system as recited in claim 1, wherein said object is a track.

9. The system as recited in claim 1, wherein said object is a skid.

10. The system as recited in claim 1, further including an antenna operatively coupled to said radio frequency identification tag.

11. The system as recited in claim 1, further including a wheel strap attached to said radio frequency transceiver for attaching said radio frequency transceiver to a wheel.

12. The system as recited in claim 1, further including a plurality of radio frequency identification tags embedded in the object at depths that are indicative of wear conditions of the object.

13. A system to detect wear of an object comprising:
a radio frequency identification tag embedded in the object;
a data processing subsystem in temporary wireless communication with the embedded radio frequency identification tag; and
a user interface operatively coupled to the data processing subsystem for providing information related to the wear conditions of the object.

14. The system as recited in claim 13, wherein the user interface is handheld.

15. The system as recited in claim 13, wherein the data processing subsystem further contains a floor mountable transceiver for communicating with said radio frequency identification tag.

16. A method for monitoring wear of an object that contains an embedded radio frequency identification tag, the method comprising the steps of:
interrogating the embedded radio frequency identification tag;
determining if the interrogation of the embedded radio frequency identification tag was successful; and
providing an indication to a user that the object is worn if the interrogation is not successful.

17. The method of claim 16, further comprising the step performed, when the interrogation of the embedded radio frequency identification tag is successful, of:
continuing to interrogate the embedded radio frequency identification tag.

18. A method for monitoring wear of an object that contains a plurality of embedded radio frequency identification tags, the method comprising the steps of:
interrogating a first embedded radio frequency identification tag;
determining if the interrogation of the first embedded radio frequency identification tag was successful;
providing an indication to a user that the object is worn if the interrogation of the first embedded radio frequency identification tag is not successful;
interrogating a second embedded radio frequency identification tag;
determining if the interrogation of the second embedded radio frequency identification tag was successful; and
providing an indication to a user that the object is worn if the interrogation of the second embedded radio frequency identification tag is not successful.

19. The method of claim 18, further comprising the step performed, when the interrogation of the second embedded radio frequency identification tag is successful, of:
continuing to interrogate the first and the second embedded radio frequency identification tags.
